(19) United States
(12) Patent Application Publication
(10) Pub. No.: US 2008/0136740 A1
(43) Pub. Date: Jun. 12, 2008

(54) MULTI-MONITOR DISPLAYING SYSTEM

(76) Inventor: Min-Chuan Wan, Hsinchu City (TW)

Correspondence Address: JOHN CHEN, ROOM 303, 3F, NO. 25, SEC. 1, CHANGAN E. ROAD, TAIPEI, 10441, omitted

(21) Appl. No.: 11/765,429

(22) Filed: Jun. 19, 2007

Related U.S. Application Data
(60) Provisional application No. 60/869,118, filed on Dec. 8, 2006.

(51) Int. Cl. G09G 5/00

(52) U.S. Cl. 345/1.1

(57) ABSTRACT

The present invention provides a system supporting multiple monitors, comprising a computer, a cable for PG-Express data transporting, a PCI-Express graphics processing unit and its memory, and a monitor.

This application claims priority to U.S. Provisional Patent Application Ser. No. 60/869,118, filed on Dec. 8, 2006, which is herein incorporated by reference in its entirety.

### BACKGROUND OF THE PRESENT INVENTION

1. Field of Invention

The invention relates to a displaying system, and more particularly to a displaying system with multiple monitors. .

2. Description of Related Arts

To increase the amount of the monitors for a computer system, there are two ways to accomplish the multi-monitor displaying system. One is to insert graphics cards into the computer system; the other is to accomplish it by connecting wired display devices to the computer system externally.

Obviously, the major drawback of inserting graphics cards into the computer system is that the chassis or case of the computer system needs to be opened. If so, there may be safety concerns. Besides, the dimensions of computer system must be larger for expansion of graphics cards.

For wired display device, it can solve these problems, but there are still some weaknesses in existing products. Existing solution of wired display devices also can be divided into two methods and both adopt USB interface.

One method uses two-chip solution, including a USB-to-PCI bridge chip and a display chip. This method needs the extra bridging chip because general display chips don't support USB interface. The need of a bridging chip increases the cost and the design complexity of the wired display device.

The other is similar to the former method. It just develops an ASIC (Application Specific Integrated Circuit) to integrate the bridge function arid the display function into a single chip.

Both of they process graphics data by CPU, not by GPU, therefore they will increase CPU burden enormously. In addition, both of they need a specific software AP to draw the display content. Besides, VGA device isn't included in USB Standard Class, so the driver of these wired display devices must be developed by special approaches. The special AP also means lots of cost, time and RD resources. And further, the bandwidth of USB is limited to 480 Mb/s. It is definitely not enough for HD (High Definition) video playback or 3D real-time application, no matter how a powerful CPU the computer system, uses.

Therefore, there is a demand to provide a new displaying system to resolve the problems mentioned above.

### SUMMARY OF THE PRESENT INVENTION

An object of the present invention is to reduce the total cost of a wired display device.

Another object of the present invention is to reduce the design complexity of a wired display device.

Another object of the present invention is to adopt PCI-Express high speed interface for graphics data transporting.

Another object of the present invention is to accomplish a multi-monitor displaying system without opening a system chassis and then inserting a new hardware into the computer inside.

Another object of the present, invention is to accomplish a multi-monitor displaying system by a general GPU, and without any specific software.

Another object of the present invention is to accomplish a multi-monitor displaying system without increasing CPU burden enormously.

Accordingly, in order to accomplish the one or some or all above objects, the displaying system comprises: a computing system; a connecting wire capable of transporting PCI-Express signals; a graphics processing module connected to the computing system through the connecting wire; and a screen connected to the graphics processing module and being capable of displaying graphics data.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates an embodiment of a displaying system in accordance with the present invention.

FIG. 2 illustrates the other embodiment of a displaying system in accordance with the present invention.

### DETAILED DESCRIPTION OF THE PREFERRED EMBODIMENT

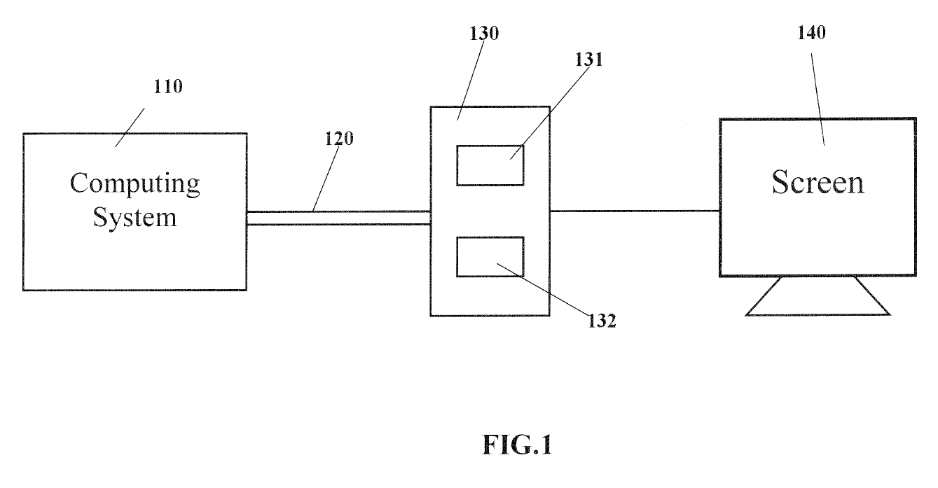

In an embodiment, referring to FIG. 1, it illustrates the displaying system in accordance with the present invention how to work. A computing system 110, such as a personal computer, notebook, or even a server, is connected to a graphics processing module 130 through a cable 120. The graphics processing module 130 includes a graphics processing unit (GPU) with PCIE interface 131 and a memory device 132, usually a DRAM The cable 120 is a kind of connecting wire capable of transporting the bidirectional data using PCI-Express protocol between the computing system 110 and the graphics processing module. The PCI-Express interface includes various bandwidths, such as PCIE 1 lane, 2 lanes, 4 lanes, 8 lanes, and 16 lanes. A screen 140 receives and displays the data processed by the PCIE GPU 131 of graphics processing module 130. The graphics processing module 130 may be built in the screen 140 (not shown) for the design option.

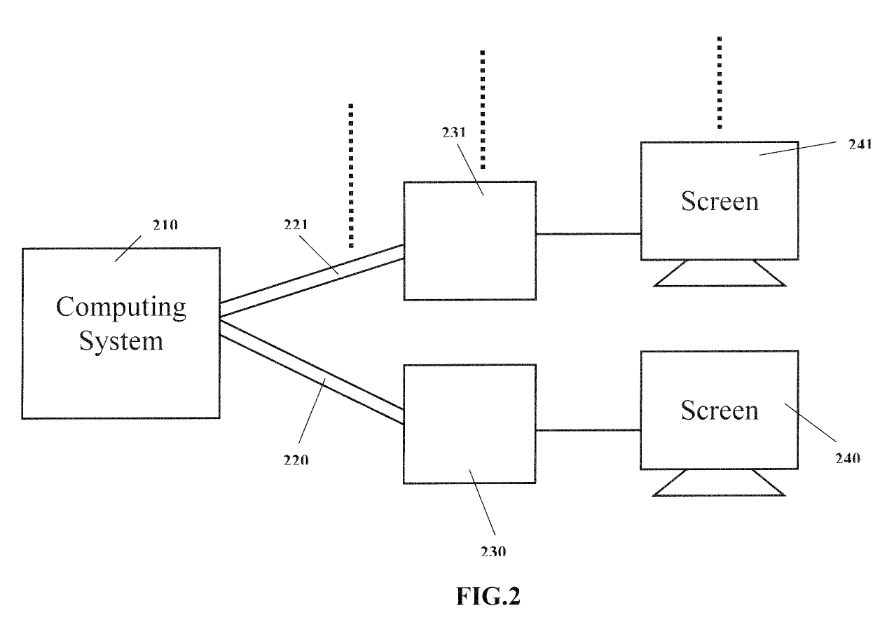

Referring to FIG. 2, it is the other embodiment of the present invention to illustrate the displaying system supporting multiple screens. It is similar to the above embodiment but a computing system displays graphics data in multiple screens. A computing system 210 is capable of being connected to multiple graphics processing modules 230, 231 . . . through the corresponding cables 220, 221 . . . Screens 240, 241 . . . receive and display the processed graphics data by the corresponding graphics processing modules 230, 231 . . . And also the graphics processing modules 230, 231 . . . can be built in the corresponding screens 240, 241 . . . for the design option.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain, the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which, all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A displaying system, comprising:
a computing system;
a connecting wire capable of transporting data using PCI-Express protocol;
a graphics processing module connected to the computing system through the connecting wire; and
a screen connected to the graphics processing module and being capable of displaying the data.

2. The displaying system according to the claim 1, wherein the graphics processing module is built in the screen,

3. The displaying system according to the claim 1, wherein the PCI-Express protocol comprises a POE 1 lane, 2 lanes, 4 lanes, 8 lanes, or 16 lanes.

4. The displaying system according to the claim 1, wherein the computing system comprises a personal computer, a notebook, or a server.

5. The displaying system according to the claim 1, wherein said graphics processing module comprises a graphics processing unit with PCIE interface and a memory device.
